(19) United States
(12) Patent Application Publication
(10) Pub. No.: US 2010/0158073 A1
(43) Pub. Date: Jun. 24, 2010

(54) ARRANGEMENT OF SENSOR ELEMENTS FOR MEASURING THE TEMPERATURE

(75) Inventor: Frank MARKS, Duesseldorf (DE)

Correspondence Address: BUCHANAN, INGERSOLL & ROONEY PC, POST OFFICE BOX 1404, ALEXANDRIA, VA, 22313-1404, US

(73) Assignee: ABB Technology AG, Zürich (CH)

(21) Appl. No.: 12/644,946

(22) Filed: Dec. 22, 2009

(30) Foreign Application Priority Data
Dec. 22, 2008 (DE) 10 2008 064 360.2

(51) Int. Cl. G01K 7/16

(52) U.S. Cl. 374/183; 374/E07.018

(57) ABSTRACT

The present disclosure provides an arrangement of sensor elements for measuring the temperature in automation systems, for example. The sensor elements are integrated in a sensor head in such a manner so as to be coupled together with a medium to be measured. With the same electrical properties, the sensor elements differ in terms of at least one physical, non-electrical property. This can be achieved by means of structural measures on the sensor head and by means of a particular nature of the sensor element itself. This may involve different fillers in which the sensor elements are embedded.

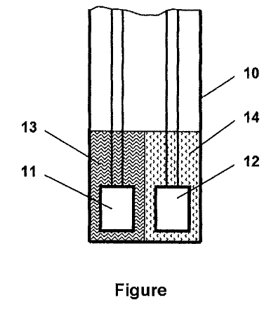

### RELATED APPLICATION

This application claims priority under 35 U.S.C. §119 to German Patent Application No. 10 2008 064 360.2 filed in Germany on Dec. 22, 2008, the entire content of which is hereby incorporated by reference in its entirety.

### FIELD

The present disclosure relates to an arrangement of sensor elements for measuring the temperature in automation systems.

It is known that, as a result of aging, the sensor elements for measuring temperature are subject to a certain drift in their characteristic curve for converting the physical variable of temperature into an electrical variable. In order to detect the changes in the sensor element, DE 102 49 411 B3 discloses the practice of redundantly designing the measuring arrangement with a first detection device and a second detection device which are set up in such a manner that the detection signals for the same measurement variable differ from one another, and the measured values from the sensor elements need to be compared with one another. For this purpose, it is proposed to connect the same resistance temperature sensors with different series resistors.

DE 10 2004 035 014 discloses that, in arrangements having a plurality of platinum resistor elements with a different rated resistance but an otherwise identical characteristic curve with a positive temperature coefficient, the common mode error results, for example as a result of the ingress of water, in poor detectability and, to some extent, impossible detectability of an absolute temperature measurement error, are determined by comparing the individual temperatures measured. It is proposed that all sensor elements in an arrangement comprising a plurality of sensor elements have temperature-dependent electrical impedances, which differ in terms of the temperature coefficient, and are integrated in a sensor head in a manner thermally coupled to one another and to the medium to be measured.

EP 0828 146 A1 describes a temperature measuring arrangement having two sensor resistors, in which the first sensor resistor has a positive temperature coefficient, and the second sensor resistor has a negative temperature coefficient and, in a series circuit comprising a series resistor and a diode, is connected in parallel with the first sensor resistor. The proper state of the sensor resistors is monitored by changing the polarity of a DC voltage applied to the temperature measuring arrangement.

The known technical solutions for detecting undesirable changes in the sensor resistors give rise to sensor resistors which are electrically different in a particular manner, and the sensor resistors involve an additional material outlay which goes beyond the measurement task, complex algorithms for carrying out and evaluating monitoring operations, as well as compensation for secondary effects from the intentional diversity of the sensor resistors.

### SUMMARY

An exemplary embodiment provides an arrangement of at least two sensor elements for measuring the temperature of a medium. The exemplary arrangement comprises a sensor head, and at least two sensor elements integrated in the sensor head so as to be coupled together with the medium to be measured. The at least two sensor elements have the same electrical properties, and the sensor elements differ in terms of at least one physical, non-electrical property.

### BRIEF DESCRIPTION OF THE DRAWINGS

Additional refinements, advantages and features of the present disclosure are described in more detail below with reference to exemplary embodiments illustrated in the drawing, in which:

The FIGURE is a partially sectioned illustration of an exemplary arrangement of sensor elements integrated in a sensor head so as to be coupled together to measure the temperature of a medium to be measured.

### DETAILED DESCRIPTION

Exemplary embodiments of the present disclosure provide an improved arrangement of at least two sensor elements for measuring the temperature of a medium. The exemplary arrangement provides an advantageous effect that undesirable changes in the sensor resistors can be effectively detected without further outlay on the apparatus.

Attention is paid to the reliable detection of drift caused by a process medium entering the sensor housing, which is encapsulated, as a result of a leak or the like, for example.

Exemplary embodiments of the present disclosure provide an arrangement of at least two sensor elements for measuring the temperature. The sensor elements can be integrated in a sensor head in such a manner so as to be coupled together with the medium to be measured.

According to the disclosure, with the same electrical properties, the sensor elements differ in terms of at least one physical, non-electrical property. This can be achieved by means of structural measures on the sensor head and by means of a particular nature of the sensor element itself. For example, the differing physical property can relate to the surface finish of the sensor elements, the density of the sensor body, the shape and type of the sensor head filling, the passivation of the sensor elements or the carrier material. This can also be achieved by using two different materials which behave differently with respect to the phenomenon to be detected.

In any event, the sensor elements differ in terms of at least one property which is not taken into consideration when dimensioning the electrical circuit comprising the sensor elements.

During operation of the measuring arrangement, the sensor elements are subjected to the same thermal and electrical load and behave in essentially the same manner within a permissible tolerance band.

With regard to the different physical properties, an undesirable and medial attack on the sensor elements which is to be detected leaves different effects which result in distinguishable measured values or changes in measured values.

The FIGURE illustrates an exemplary embodiment of an arrangement of sensor elements for measuring temperature. The exemplary arrangement can be implemented to measure the temperature in automation systems, for example. The FIGURE shows a partially sectioned illustration of a measuring tip of a sensor head 10 which is fitted with two sensor elements 11 and 12. The sensor elements 11 and 12 are integrated in the sensor head 10 in such a manner so as to be coupled together with the medium to be measured. The exemplary arrangement is described with reference to an example of measuring the temperature of a conductive liquid, such as water, for example. It is to be understood that the measurement of such a conductive liquid is an example of a type of the medium whose temperature can be measured by the exemplary arrangement, and the present disclosure is not limited thereto.

The sensor elements 11 and 12 are each embedded in different fillers 13 and 14 which differ in terms of at least one physical, non-electrical property. For example, the fillers 13 and 14 can differ with respect to their porosity. An exemplary embodiment is described below in which the filler 13 is made of a spongy material, and the filler 14 has a dense surface.

If the sensor head 10 is broken, the surrounding medium (e.g., water) can enter the sensor head 10 and advance to the sensor elements 11 and 12. In this example, the spongy filler 13 would have a lower resistance than the filler 14 with the dense surface. As a result, the sensor element 11 is wetted more intensively by the entering water than the sensor element 12. The medial attack of the entering water on the sensor elements 11 and 12 leaves different effects which result in distinguishable measured values or changes in measured values.

Although the different wetting intensity of the sensor elements 11 and 12 will also result in a common mode error, the different wetting intensity can also result in shunts which can be metrologically distinguished from each other, and the difference therebetween can be assessed as drift.

As described above, the sensor elements 11 and 12 differ in terms of at least one physical, non-electrical property. In the above-described exemplary embodiment, the sensor elements 11 and 12 differ in terms of their porosity. Exemplary embodiments of the present disclosure also provide that the sensor elements 11 and 12 can differ with respect to other physical, non-electrical properties. For example, the sensor elements 11 and 12 can differ in terms of their respective surface finishes, the density of the sensor body, such as the density of the respective fillers 13 and 14, the shape and type of the fillers 13 and 14, the shape and type of a filling of the sensor head 10, as well as the passivation of the sensor elements 11 and 12 or a carrier material. In addition, a physical, non-electrical difference between the sensor elements 11 and 12 can be achieved by the implementation of two different materials which behave differently with respect to the medium to be measured and/or the phenomenon to be detected.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

10 Sensor head
11, 12 Sensor element
13, 14 Filler

What is claimed is:

1. An arrangement of at least two sensor elements for measuring the temperature of a medium, comprising:
a sensor head;
at least two sensor elements integrated in the sensor head so as to be coupled together with the medium to be measured,
wherein the at least two sensor elements have the same electrical properties, and the sensor elements differ in terms of at least one physical, non-electrical property.

2. The arrangement as claimed in claim 1, wherein the sensor elements differ in terms of their surface finish.

3. The arrangement as claimed in claim 1, wherein the sensor elements differ in terms of a respective density of a sensor body accommodating the at least two sensors, respectively.

4. The arrangement as claimed in claim 1, wherein the sensor elements are accommodated in the sensor head, and a shape of the sensor head causes a different load to be placed on the sensor elements.

5. The arrangement as claimed in claim 1, wherein the sensor elements in the sensor head are embedded in different fillers.

6. The arrangement as claimed in claim 1, wherein the sensor elements in the sensor head have different passivations.

7. The arrangement as claimed in claim 1, wherein the sensor elements in the sensor head are arranged on different carrier materials.

8. The arrangement as claimed in claim 1, wherein the sensor elements are constituted by two different materials which behave differently with respect to a phenomenon to be detected.

9. The arrangement as claimed in claim 1, wherein the at least two sensors are configured to measure the temperature in an automation system.

10. The arrangement as claimed in claim 1, comprising at least two fillers into which the at least two sensor elements are embedded, respectively, the at least two fillers having a different porosity.
